(19) United States
(12) Patent Application Publication
(10) Pub. No.: US 2022/0245860 A1
(43) Pub. Date: Aug. 4, 2022

(54) ANNOTATION OF TWO-DIMENSIONAL IMAGES

(71) Applicant: INAIT SA, Lausanne (CH)

(72) Inventors: Constantin Cosmin Atanasoaei, Chavannes-pres-Renens (CH); Daniel Milan Lütgehetmann, Lausanne (CH); Dimitri Zaganidis, Granges (CH); John Rahmon, Lausanne (CH); Michele De Gruttola, Geneva (CH)

(21) Appl. No.: 17/179,596

(22) Filed: Feb. 19, 2021

(30) Foreign Application Priority Data
Feb. 2, 2021 (GR) 20210100068

(51) Int. Cl. G06T 7/73; G06T 19/00; G06N 20/00

(52) U.S. Cl. CPC G06T 7/75; G06T 19/00; G06T 2207/20081; G06T 2219/004; G06N 20/00

(57) ABSTRACT

Methods, systems, and apparatus, including computer programs encoded on a computer storage medium, for processing images that involves annotation of landmarks on two-dimensional images. In one aspect methods are performed by data processing apparatus for training a device for estimating the relative pose of an imaging device and an object in a two-dimensional image. The methods include identifying a 3D model of the object, identifying landmarks on the 3D model of the object, projecting the 3D model into a collection of two-dimensional images with knowledge of the location of the landmarks from the 3D model on the projection, and training a landmark-detection machine learning model to identify the landmarks in the collection of two-dimensional images. The landmark-detection machine learning model is part of a device for estimating the relative pose of an imaging device.

### CROSS-REFERENCE TO RELATED APPLICATION

This application claims priority to Greek Application No. 20210100068, filed Feb. 2, 2021, the contents of which are incorporated by reference herein.

### BACKGROUND

This specification relates to image processing, more specifically, to image processing that involves annotation of landmarks on two-dimensional images.

Image processing is a type of signal processing in which the processed signal is an image. An input image can be processed, e.g., to produce an output image or a characterization of the image.

In many cases, annotation of an image can facilitate processing of the image, especially in image processing techniques that rely upon machine learning. Annotation can label entities or parts of entities in images with structured information or metadata. The label can indicate, e.g., a class (e.g., cat, dog, arm, leg), a boundary, a corner, a location, or other information. The labels can be used in a variety of contexts, including those that rely upon machine learning and/or artificial intelligence. For example, a collection of annotated images can form a training dataset for pose estimation, image classification, feature extraction, and pattern recognition in contexts as diverse as medical imaging, self-driving vehicles, damage assessment, facial recognition, and agriculture. Currently, machine learning and artificial intelligence models require large datasets that are customized to the particular task performed by the model.

### SUMMARY

This specification describes technologies relating to image processing that involves annotation of landmarks on two-dimensional images.

In one implementation, the subject matter described in this specification can be embodied in methods performed by data processing apparatus for training a device for estimating the relative pose of an imaging device and an object in a two-dimensional image. The methods include identifying a 3D model of the object, identifying landmarks on the 3D model of the object, projecting the 3D model into a collection of two-dimensional images with knowledge of the location of the landmarks from the 3D model on the projection, and training a landmark-detection machine learning model to identify the landmarks in the collection of two-dimensional images. The landmark-detection machine learning model is part of a device for estimating the relative pose of an imaging device.

This and other implementations can include one or more of the following features. The methods can include estimating relative poses of the object in two-dimensional images using the device that includes the landmark-detection machine learning model, determining a correctness of the estimates of the relative poses, and further training the landmark-detection machine learning model based on the correctness of the estimates of the relative poses. The relative poses of the object can be estimated in the collection of two-dimensional images into which the 3D model is projected. The correctness of the estimates of the relative poses can be determined by constraining relative poses of the projections of the 3D model into the collection of two-dimensional images, and classifying any estimate of the relative pose that does not satisfy the constraints as incorrect. Identifying the landmarks on the 3D model of the object can include rendering a collection of two-dimensional images of the object by projecting the 3D model of the object onto two dimensions, assigning different regions of the object in the two-dimensional images to respective parts of the object, determining distinguishable regions of the parts of the object using the assigned regions, and projecting the distinguishable regions back onto the 3D model of the object to identify the landmarks on the 3D model of an object.

In another implementation, the subject matter described in this specification can be embodied in methods performed by data processing apparatus for estimating the relative pose of an imaging device and an object in a two-dimensional image of the object. The methods include detecting landmarks on the object in the two-dimensional image, filtering the plurality of landmarks to establish a plurality of subsets of the detected landmarks, calculating, using each of the respective subsets of the detected landmarks, candidate relative poses of the object in the two-dimensional image, and estimating the relative pose of an imaging device and an object based on at least one of the candidate relative poses. The methods can include filtering the candidate relative poses of the object. The criteria for filtering the candidate relative poses can reflect real-world conditions in which a real image is likely to be taken. Estimating the relative pose of the imaging device and the object can include averaging multiple of the candidate relative poses. Detecting the landmarks on the object can include detecting the landmarks using a landmark-detection machine learning model. The landmark-detection machine learning model can have been trained by a process that includes identifying a 3D model of the object, identifying landmarks on the 3D model of the object, projecting the 3D model into a collection of two-dimensional images with knowledge of the location of the landmarks from the 3D model on the projection, and training the landmark-detection machine learning model to identify the landmarks in the collection of two-dimensional images.

In another implementation, the subject matter described in this specification can be embodied in methods performed by data processing apparatus for identifying landmarks on a 3D model of an object. The methods include rendering a collection of two-dimensional images of an object by projecting the 3D model of the object onto two dimensions, assigning different regions of the object in the two-dimensional images to respective parts of the object, determining distinguishable regions of the parts of the object using the assigned regions, and projecting the distinguishable regions back onto the 3D model of the object to identify the landmarks on the 3D model of an object.

This and other implementations can include one or more of the following features. Determining the distinguishable regions of the parts comprises detecting corners of projections of the parts in the two-dimensional images. The method can include reducing a number of the distinguishable regions prior to projection back onto the 3D model. The number of the distinguishable regions can be reduced by filtering distinguishable regions that are close to an outer boundary of the object. The number of the distinguishable regions can be reduced by clustering back-projections of the distinguishable regions onto the 3D model from different of the two-dimensional images and discarding outliers of the distinguishable regions. Rendering the collection of two-dimensional images of the object can include permuting the object and projecting the permutations of the 3D model onto two dimensions. Rendering the collection of two-dimensional images of the object can include varying to rendering to mimic variation in a characteristic of an imaging apparatus, to mimic variation in a characteristic of image processing applicable to two-dimensional images, or to mimic variation in an imaging condition.

Other embodiments of the above-described methods include corresponding systems and apparatus configured to perform the actions of the methods, and computer programs that are tangibly embodied on machine-readable data storage devices and that configure data processing apparatus to perform the actions.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic representation of the acquisition of a collection of different images of an object.

FIG. 2 is a schematic representation of a collection of two-dimensional images acquired by one or more cameras.

FIG. 3 is a flowchart of a computer-implemented process for processing photographic images of an object.

FIG. 4 is a flowchart of a computer-implemented process for annotating landmarks that appear on a 3D model.

FIGS. 5A, 5B, 5C, 5D show example results from the annotation of landmarks on a 3D model of an automobile.

FIG. 6 is a flow chart of a process for producing landmark detector that is capable of detecting landmarks in real two-dimensional images using an annotated 3D model.

FIG. 7 is a flowchart of a process for recognizing relative poses between an imaging device and an object using a machine-learning model for landmark detection.

FIG. 8 is a histogram that represents the accuracy of an example machine learning model for landmark detection that has been produced using the process of FIG. 6.

FIG. 9 is a histogram that represents the accuracy of relative pose predictions made using the process of FIG. 7.

Like reference numbers and designations in the various drawings indicate like elements.

### DETAILED DESCRIPTION

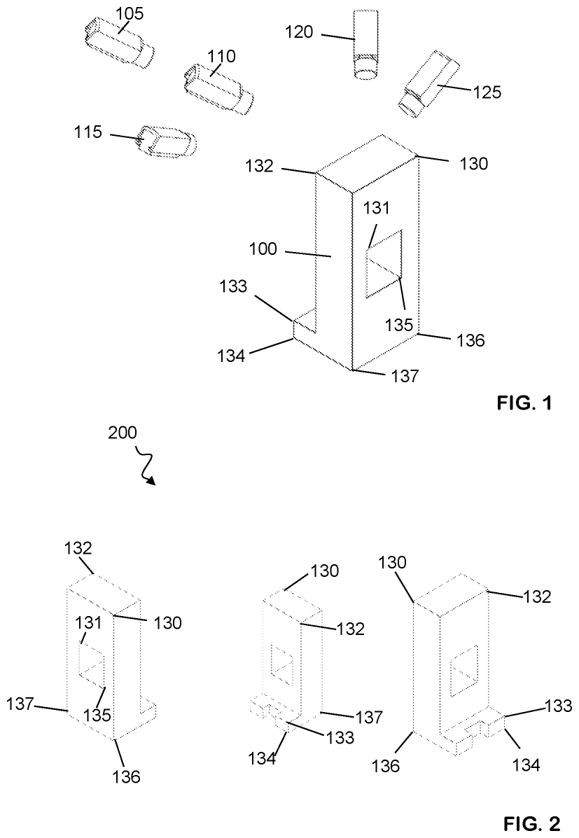

FIG. 1 is a schematic representation of the acquisition of a collection of different images of an object 100. For illustrative purposes, object 100 is shown as an assembly of ideal, unmarked geometric parts (e.g., cubes, polyhedrons, parallelepipeds, etc.). However, in real-world applications, objects will generally have a more complicated shape and be textured or otherwise marked, e.g., with ornamental decoration, wear marks, or other markings upon the underlying shape.

A collection of one or more imaging devices (here, illustrated as cameras 105, 110, 115, 120, 125) can be disposed successively or simultaneously at different relative positons around object 100 and oriented at different relative angles with respect to object 100. The positions can be distributed in 3-dimensional space around object 100. The orientations can also vary in 3-dimensions, i.e., the Euler angles (or yaw, pitch, and roll) can all vary. The relative positioning and orientation of a camera 105, 110, 115, 120, 125 with respect to object 100 can be referred to as the relative pose. Since cameras 105, 110, 115, 120, 125 have different relative poses, cameras 105, 110, 115, 120, 125 will each acquire different images of object 100.

Even a simplified object like object 100 includes a number of landmarks 130, 131, 132, 133, 134, 135, 136, . . . . A landmark is a position of interest on object 100. Landmarks can be positioned at geometric locations on an object or at a marking upon the underlying geometric shape. As discussed further below, landmarks can be used for determining the pose of the object. Landmarks can also be used for other types of image processing, e.g., for classifying the object, for extracting features of the object, for locating other structures on the object (geometric structures or markings), for assessing damage to the object, and/or for serving as point of origin from which measurements can be made in these and other image processing techniques.

FIG. 2 is a schematic representation of a collection 200 of two-dimensional images acquired by one or more cameras, such as cameras 105, 110, 115, 120, 125 (FIG. 1). The images in collection 200 show object 100 at different relative poses. Landmarks like landmarks 130, 131, 132, 133, 134, 135, 136, . . . appear at different locations in different images-if they appear at all. For example, in the leftmost image in collection 200, landmarks 133, 134 are obscured by the remainder of object 100. In contrast, in the rightmost image 210, landmarks 131, 135, 137 are obscured by the remainder of object 100.

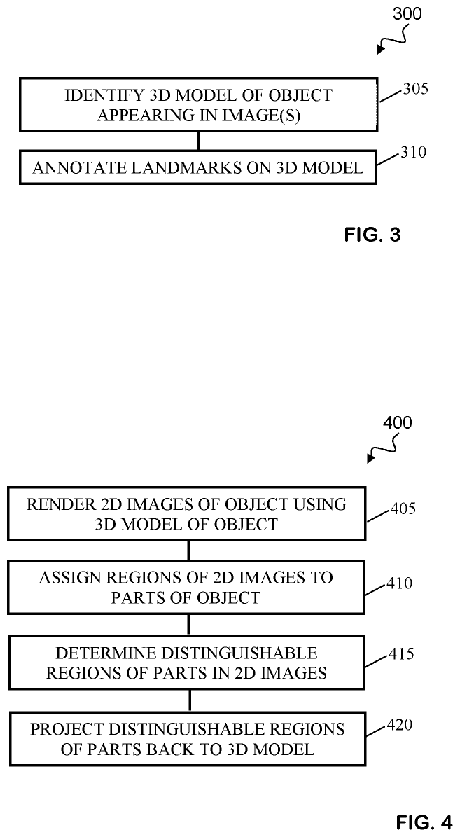

FIG. 3 is a flowchart of a computer-implemented process 300 for processing photographic images of an object, such as images 205, 210, 215, 220 (FIG. 2). Process 300 can be performed by one or more data processing devices that perform data processing activities. The activities of process 300 can be performed in accordance with the logic of a set of machine-readable instructions, a hardware assembly, or a combination of these and/or other instructions.

As discussed above, depending on the captured pose, landmarks on an object can appear at different locations in different photographic images. Process 300 produces a landmark detector that has been trained using machine learning techniques to identify landmarks in photographic images of an object. The identified landmarks can be used in a variety of different image processing applications, including pose estimation, image classification, feature extraction, pattern recognition, and others. Process 300 can thus be performed independently or as part of a larger collection of activities. For example, process 300 can be performed in conjunction with process 400 (FIG. 4).

Please note that although the present specification refers to photographic or real “images of an object,” these images are generally not images of a single physical instance of an object. Rather, the images of an object are generally images of several different instances of different objects that share common visually-identifiable characteristics. Examples include different instances of a make and model of a car or of an appliance, different instances of an animal taxonomic group (e.g., instances of a species or of a gender of a species), and different instances of an organ (e.g., x-ray images of femurs from 100 different humans). Further, the photographic or real images can be, e.g., digital photographic images or, alternatively, can be formed using X-rays, sound, or other imaging modality. The images can either be in digital or in analog format.

At 305, the device performing process 300 identifies a 3D model of a physical object that appears in one or more images that are to be processed. The 3D model can represent the object in three-dimensional space, generally divorced from any frame of reference. 3D models can be created manually, algorithmically (procedural modeling), or by scanning real objects. Surfaces in a 3D model may be defined with texture mapping.

In many cases, a single 3D model will include several different constituent parts. Parts of an object are pieces or volumes of the object and are generally distinguished from other pieces or volumes of the object, e.g., on the basis of function and/or structure. For example, the parts of an automobile can include, e.g., bumpers, wheels, body panels, the hood, windshields, and hoods. The parts of an organ can include, e.g., chambers, valves, cavities, lobes, canals, membranes, vasculature, and the like. The parts of a plant can include roots, stems, leaves, and flowers. Depending on the nature of the 3D model, the 3D model may itself be divided into 3D models of the constituent parts. For example, a 3D model of an automobile generated using computer-aided design (CAD) software may be an assembly of 3D CAD models of the constituent parts. However, in other cases, a 3D model can start as a unitary whole that is subdivided into constituent parts. For example, a 3D model of an organ can be divided into various constituent parts under the direction of a medical or other professional.

In some cases, data that identifies the object that appears in the image(s) can be received from a human user. For example, a human user can indicate the make, model, and year of an automobile that appears in the image(s). In other cases, a human user can indicate the identity of an human organ or the species of a plant that appears in the image(s). In other implementations, the object can be identified using image classification techniques. For example, convolutional neural network can be trained to output a classification label for an object or a part of an object in an image.

A 3D model of the object can be identified in a variety of different ways. For example, a pre-existing library of 3D models can be searched using data that identifies the object. Alternatively, a manufacturer of a product can be requested to provide a 3D model or a physical object can be scanned.

At 310, the device performing process 300 annotates landmarks that appear on the 3D model. As discussed above, these landmarks are positions of interest on the 3D model and can be identified and annotated on the 3D model.

FIG. 4 is a flowchart of a computer-implemented process 400 for annotating landmarks that appear on a 3D model. Process 400 can be performed by one or more data processing devices that perform data processing activities, e.g., in accordance with the logic of a set of machine-readable instructions, a hardware assembly, or a combination of these and/or other instructions. Process 400 can be performed in isolation or in conjunction with other activities. For example, process 400 can be performed at 310 in process 300 (FIG. 3).

At 405, the system performing process 400 renders a collection of two-dimensional images of the object using a 3D model of the object that is formed of constituent parts. The two-dimensional images are not actual images of a real-world object. Rather, the two-dimensional images can be thought of as surrogates for images of the real world object. These surrogate two-dimensional images show the object from a variety of different angles and orientations—as if a camera were imaging the object from a variety of different relative poses.

The two-dimensional images can be rendered using the 3D model in a number of ways. For example, ray tracing or other computer graphic techniques can be used. In general, the 3D model of the object is perturbed for rendering the surrogate two-dimensional images. Different surrogate two-dimensional images can thus illustrate different variations of the 3D model. In general, the perturbations can mimic real-world variations in the objects—or parts of the objects—that are represented by the 3D model. For example, in 3D models of automobiles, the colors of the exterior paint and the interior decor can be perturbed. In some cases, parts (tires, hubcaps, and features like roof carriers) can be added, removed, or replaced. As another example, in 3D models of organs, physiologically relevant size and relative size variations can be used to perturb the 3D model.

In some implementations, aspects other than the 3D model can be perturbed to further vary the two-dimensional images. In general, the perturbations can mimic real-world variations including, e.g.,
variations in imaging devices (e.g., camera resolution, zoom, focus, aperture speed),
variations in image processing (e.g., digital data compression, chroma subsampling), and
variations in imaging conditions (e.g., lighting, weather, background colors and shapes).

In some implementations, the two-dimensional images are rendered in a frame of reference. The frame of reference can include background features that appear behind the object and foreground features that appear in front of—and possibly obscure part of—the object. In general, the frame of reference will reflect the real-world environment in which the object is likely to be found. For example, an automobile may be rendered in a frame of reference that resembles a parking lot, whereas an organ may be rendered in a physiologically relevant context. The frame of reference can also be varied to further vary the two-dimensional images.

In general, it is desirable that the two-dimensional images are highly variable. Further, the number of surrogate two-dimensional images—and the extent of the variations—can depend on the complexity of the object and the image processing that is ultimately to be performed using the annotated landmarks on the 3D model. By way of example, 2000 or more highly variable (in relative pose and permutation) surrogate two-dimensional images of an automobile can be rendered. Because the two-dimensional images are rendered from a 3D model, perfect knowledge about the position of the object in the two-dimensional images can be retained regardless of the number of two-dimensional images and the extent of variation.

At 410, the system performing process 400 assigns each region of an object shown in the two-dimensional images to a part of the object. As discussed above, a 3D model of an object can be divided into distinguishable constituent parts on the basis of function and/or structure. When a surrogate two-dimensional image of the 3D model is rendered, the part to which each region in the two-dimensional image belongs can be preserved. The regions which can be pixels or other areas in the two-dimensional image—can thus be assigned to corresponding constituent parts of the 3D model with perfect knowledge derived from the 3D model.

At 415, the system performing process 400 determines distinguishable regions of the parts in the two-dimensional images. A distinguishable region of a part is an area (e.g., a pixel or group of pixels) that can identified in the surrogate two-dimensional images using one or more image processing techniques. For example, in some implementations, corners of the regions in each image that are assigned to the same part are detected using, e.g., a Moravec corner detector or a Harris Corner Detector (https://en.wikipedia.org/wiki/Harris_Corner_Detector). As another example, an image feature detection algorithm such as, e.g. SIFT/SURF/HOG/(https://en.wikipedia.org/wiki/Scale-invariant_feature_transform) can be used to define distinguishable regions.

At 420, the system performing process 400 identifies a collection of landmarks in the 3D model by projecting the distinguishable regions in the two-dimensional images back onto the 3D model. Volumes on the 3D model that correspond to the distinguishable regions in the two-dimensional images are identified as landmarks on the 3D model.

In some implementations, one or more filtering techniques can be applied to reduce the number of these landmarks and to ensure quality—either before or after back-projection onto the 3D model. For example, in some implementations, regions that are close to an outer boundary of the object in the surrogate two-dimensional image can be discarded prior to back-projection. As another example, back-projections of regions that are too distant from a corresponding part in the 3D model can be discarded.

In some implementations, only volumes on the 3D model that satisfy a threshold standard are identified as landmarks. The threshold can be determined in a number of ways. For example, the volumes that are candidate landmarks on the 3D model and identified by back-projection from different two-dimensional images rendered with different relative poses and perturbations can be collected. Clusters of candidate landmarks can be identified and outlier candidate landmarks can be discarded. For example, clustering techniques such as the OPTICS algorithm (https://en.wikipedia.org/wiki/OPTICS_algorithm), a variation of DBSCAN https://en.wikipedia.org/wiki/DBSCAN) can be used to identify clusters of candidate landmarks. The effectiveness of the clustering can be evaluated using, e.g., Calinski-Harabasz index (i.e., the Variance Ratio Criterion) or other criterion. In some implementations, the clustering techniques can be selected and/or tailored (e.g., by tailoring hyper-parameters of the clustering algorithm) to improve the effectiveness of clustering. If needed, candidate landmarks that are in a cluster and closer together than a threshold can be merged. In some implementations, candidate landmarks clusters that are on different parts of the 3D model can also be merged into a single cluster. In some implementations, the barycenters of several candidate landmarks in a cluster can be designated as a single landmark.

In some implementations, the landmarks in the 3D model can be filtered on the basis of the accuracy with which their position in surrogate two-dimensional images rendered from the 3D model can be predicted. For example, if the position of 3D landmark in a two-dimensional image is too difficult to predict (e.g., incorrectly predicted above a threshold percent of the time or predicted only with a poor accuracy), then that 3D landmark can be discarded. As a result, only 3D landmarks with positions in two-dimensional images that the landmark predictor can be predict relatively easily will remain.

In some instances, the number of landmarks that are identified can be tailored to a particular data processing activity. The number of landmarks can be tailored in a number of ways, including, e.g.,:
at 405, rendering more or fewer two-dimensional images, especially using more or fewer permutations of the 3D model;
dividing the 3D model into more or fewer parts to which regions are assigned at 410;
relaxing or tightening a constraint for considering a region to be distinguishable at 415; and/or
relaxing or tightening constraints for filtering landmarks after back-projecting the distinguishable regions onto the 3D model after 420.

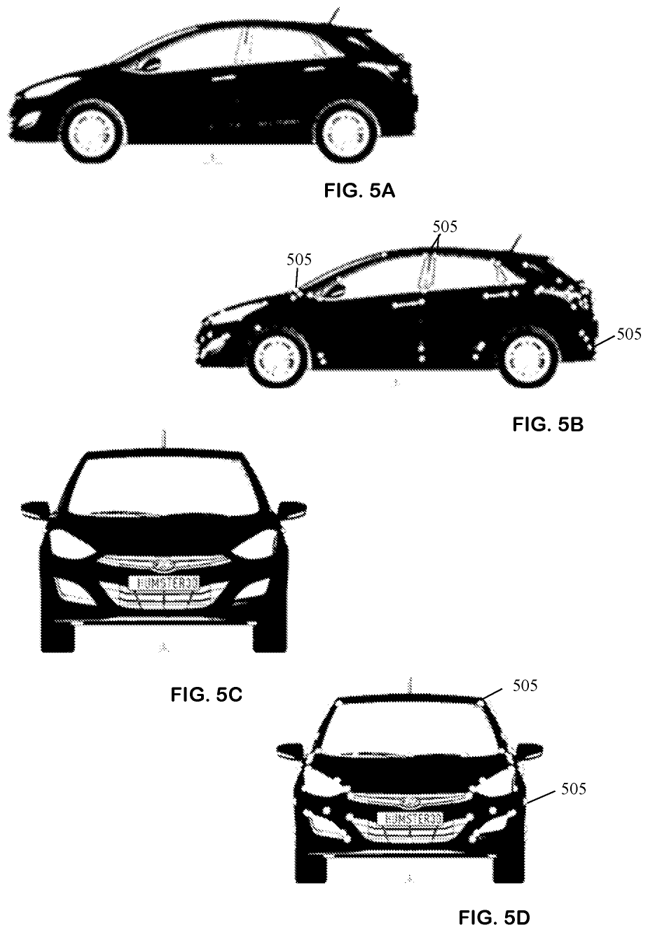

FIGS. 5A, 5B, 5C, 5D show example results from the annotation of landmarks on a 3D model, namely, a 3D model of an automobile. In particular, FIGS. 5A, 5C show side and front views of a 3D model of an automobile, whereas FIGS. 5B, 5D show side and front views of the same 3D model, but with a collection of landmark annotations 505. For illustrative purposes, each landmark annotation 505 is schematically represented as a white dot on the 3D model. As shown, landmark annotations 505 tend to be positioned at the corners of different parts of the automobile, including the corners of the windshield, side windows, and grillwork. This is consistent with the use of corner detection to determine distinguishable regions of the parts in the surrogate two-dimensional images (e.g., at 415 in process 400). Further, landmark annotations tend not to be positioned on the corners of parts that are often found at the outer boundary of the automobile, such as the corner of the side mirrors. This is consistent with filtering such corners prior to back-projection (e.g., prior to 420 in process 400).

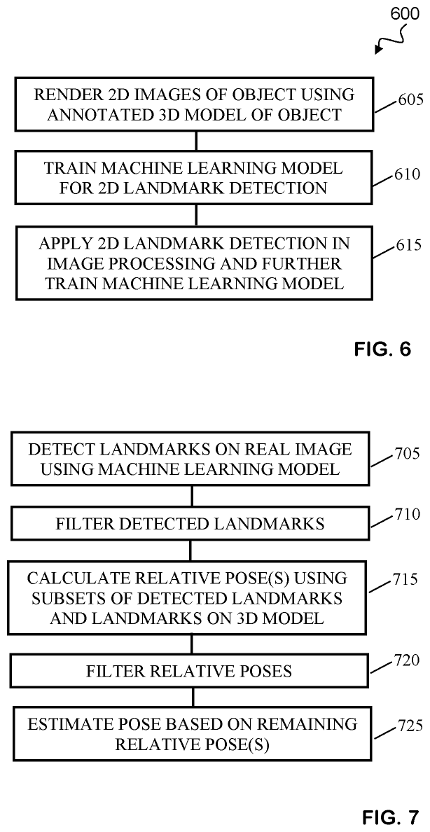

As discussed above, annotated 3D models can be used when performing a variety of different image processing techniques. FIG. 6 is a flow chart of a process for producing landmark detector that is capable of detecting landmarks in real two-dimensional images using an annotated 3D model. Process 600 can be performed by one or more data processing devices that perform data processing activities, e.g., in accordance with the logic of a set of machine-readable instructions, a hardware assembly, or a combination of these and/or other instructions. Process 600 can be performed in isolation or in conjunction with other activities. For example, process 600 can be performed after 310 in process 300 (FIG. 3).

At 605, the system performing process 600 renders a collection of two-dimensional images of the object using an annotated 3D model of the object. Ray tracing or other computer graphic techniques can be used. As before, it is generally desirable that the two-dimensional images are as variable as possible. A variety of different relative poses and/or perturbations in the object, the imaging device, image processing, and imaging conditions can be used to generate a diverse collection of two-dimensional images. In implementations where process 600 is performed in conjunction with process 400, new renderings need not be generated. Rather, existing renderings can simply be annotated by adding appropriate annotations from the 3D model with perfect knowledge derived from the 3D model.

At 610, the system performing process 600 trains a machine learning model for landmark detection in real-world two-dimensional images using the two-dimensional images rendered using the annotated 3D model of the object. An example machine learning model for landmark detection is the detectron2 available at https://github.com/facebookresearch/detectron2.

At 615, the system performing process 600 applies the machine learning model for two-dimensional landmark detection that has been trained using the surrogate two-dimensional images in a particular type of image processing. Further, the same machine learning model can be further trained by rejecting certain results of the image processing as incorrect.

In more detail, as discussed above, landmark detection can be used, e.g., in image classification, feature extraction, pattern recognition, pose estimation, and projection. A training set that is developed using the surrogate two-dimension images rendered from the 3D model can be used to further train the machine learning model for landmark detection to the particular image processing.

By way of example, the two-dimensional landmark detection machine learning model can be applied to pose recognition. In particular, the correspondences between landmarks detected on the surrogate two-dimensional images and landmarks on the 3D model can be used to determine the relative poses of the object in the surrogate two-dimensional images. Those pose predictions can be reviewed to invalidate poses that do not satisfy certain criteria. In some implementations, the criteria for invalidating a pose prediction are established based on the criteria that used when rendering the surrogate two-dimensional images from the 3D model. For example, if the relative poses of the imaging device and the object are constrained when rendering the surrogate two-dimensional images (e.g., a range of relative angles or positions), predicted poses that fall outside those constraints can be labeled as incorrect and used, e.g., as negative examples in further training of the machine learning model for landmark detection.

In other implementations, the predicted poses can be limited to criteria that are independent of any criteria that are used when rendering the surrogate two-dimensional images from the 3D model. For example, the predicted poses can be limited to poses that are likely to be found in real-world pose prediction. Poses that are rejected under such criteria would not necessarily be useful as negative examples, but rather simply omitted since landmark detection need not be performed outside of realistic conditions.

Regardless of whether the criteria are or are not used when rendering the surrogate two-dimensional images from the 3D model, predicted poses can be constrained, e.g., to a defined range of distances between the camera and the object (e.g., between 1-20 meters) and/or a defined range of roll along the axis between the camera and the center of the object (e.g., less than +/−10 degrees).

As another example, other computer-implemented techniques can be used to reject pose predictions as incorrect. For example, a variety of computer-implemented techniques—including computer graphic techniques (e.g., ray tracing) and computer vision techniques (e.g., semantic segmentation and active contours models) can be used to identify the boundary of an object. If the boundary of the object identified by such a technique does not match the boundary of the object that would result from the predicted pose, the predicted pose can be rejected as incorrect.

Process 600 can thus further tailor landmark detection machine learning model to a particular type of image processing without reliance on real images during training.

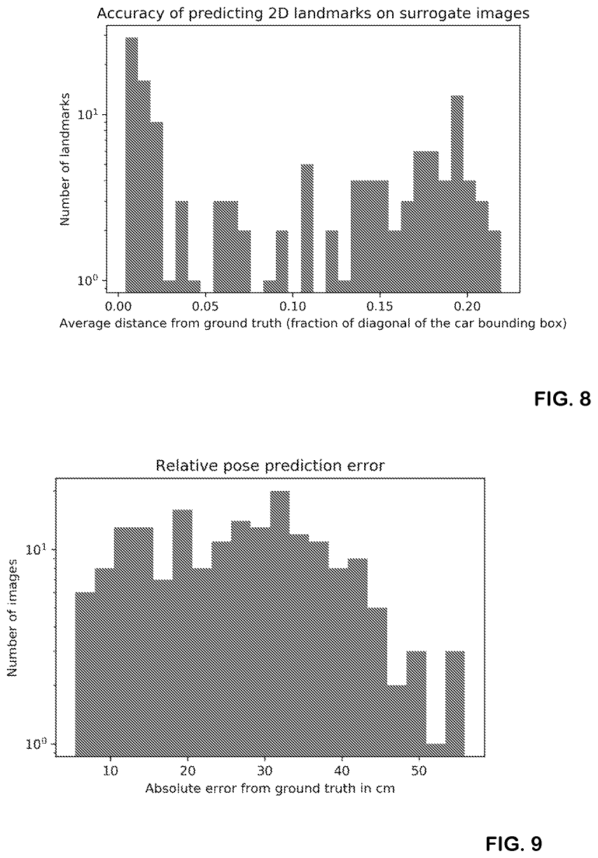

FIG. 8 is a histogram that represents the accuracy of an example machine learning model for landmark detection that has been produced using process 600 (FIG. 6). In the histogram, position along the y-axis indicates the number count of landmarks. Position along the x-axis indicates the average distance over all images between a) the position of each two-dimensional landmark in a surrogate two-dimensional image—as predicted by the machine learning model and b) the actual position of the corresponding two-dimensional landmark in the surrogate two-dimensional image—as calculated by ray-tracing from the corresponding 3D model. The distance is normalized by the diagonal length of a rectangle that fully contains the automobile at the same relative pose as the surrogate two-dimensional image. Thus, a distance of 0.1 indicates that the predicted position of the two-dimensional landmark is 10% of the size of the automobile away from the actual position of that landmark, as calculated from the 3D model.

FIG. 7 is a flowchart of a process 700 for recognizing relative poses between an imaging device and an object using a machine-learning model for landmark detection. Process 700 can be performed by one or more data processing devices that perform data processing activities, e.g., in accordance with the logic of a set of machine-readable instructions, a hardware assembly, or a combination of these and/or other instructions. Process 700 can be performed in isolation or in conjunction with other activities. For example, process 700 can be performed after process 600 (FIG.6), using a machine learning model for landmark detection that is produced in that process and tailored to pose recognition.

For humans and animals, it is an every-day action to faithfully assess their own position with respect to other objects from a simple visual sighting of the objects. Such assessments are necessary for many basic actions, including reaching, handling, and avoiding objects. For machines, faithfully inferring the position of an object is more difficult, especially if only two-dimensional (non-stereoscopic) images are available. Indeed, unlike humans and animals who use their eyes to define a default frame of reference, a machine must estimate both the pose of the observer (e.g., a camera) as well as the pose of the imaged object.

The pose recognition implemented by process 700 provides a high-quality estimation of the relative pose of the camera and an object that is at least partially visible in a real-world two-dimensional image.

At 705, the system performing process 700 detects landmarks on a real two-dimensional image of an object using a machine-learning model for landmark detection. In some implementations, the machine learning model for landmark detection is produced using process 600 (FIG.6). The landmarks in the real, two-dimensional image will be two-dimensional landmarks.

At 710, the system performing process 700 filters the detected two-dimensional landmarks to yield one or more subsets of the detected landmarks. In some implementations, the filtering can include determining a correspondence between:
landmarks on a 3D model of the object, and
the detected two-dimensional landmarks.

For example, a collection of pairs of two-dimensional landmarks (detected in the real image) and three-dimensional landmarks (present on the 3D model of the object) can be determined.

Various filtering operations can be used to prefilter these pairs and yield subset(s) of the detected landmarks and corresponding landmarks on the 3D model. For example, two-dimensional landmarks from the real image that are close to the outer boundary of the object in the real image can be removed. The boundary of the object can be identified in a variety of different ways, including, e.g., computer vision techniques. In some instances, the boundary of the object can be detected using the same landmarks detected by the machine-learning model for landmark detection at 705.

As another example of a filtering operation, two-dimensional landmarks detected by the machine-learning model and that are close to one another in the real two-dimensional image can be filtered at random so that at least one landmark remains in the vicinity. The distance between two-dimensional landmarks can be measured, e.g., in pixels. In some implementations, two-dimensional landmarks are designated as close if their distance is, e.g., 2% the width or height of the image or less or 1% the width or height of the image or less.

As yet another example of a filtering operation, one or more landmarks on the 3D model can be swapped with other symmetric landmarks on the 3D model. For example, in implementations where the object is an automobile, landmarks on the 3D model at the passenger's side of the automobile can be swapped with landmarks at the driver's side. For objects that have other symmetrical or near-symmetrical relationships (e.g., rotational about a point or axis), correspondingly tailored swapping of landmarks can be used.

At 715, the system performing process 700 calculates one or more candidate relative poses for the camera and the object using the subset(s) of the detected landmarks. The relative poses can be calculated in a variety of different ways. For example, a computer vision approach such as SolvePnP with random sample consensus (available at the OpenCV library https://docs.opencv.org/4.4.0/d9/d0c/group_calib3d.html#ga549c2075fac14829ff4a58bc931c033d) can be used to solve the so-called “perspective-n-point problem” and calculate a relative pose based on pairs of two-dimensional and three-dimensional landmarks.

Such computer vision approaches tend to be resilient to outliers, i.e., pairs of landmarks where the detected 2D landmark location is far from the actual location. However, computer vision approaches are often not resilient enough to consistently overcome common imperfections in landmark detectors, including, e.g., two-dimensional landmarks that are invisible in a real image but are predicted to be in the corners of the real image or at the edges of the object, landmarks that cannot reliably be identified as either visible or hidden behind the object, predictions of two-dimensional landmarks that are either unreliable or inaccurate, symmetric landmarks that are exchanged for one another, visually similar landmarks that are detected at the same location, and detection of multiple, clustered landmarks in regions with a complex local structures. By filtering the detected two-dimensional landmarks at 710, the system performing process 700 can avoid these issues.

At 720, the system performing process 700 filters the candidate relative pose(s) calculated using the subset(s) of the detected landmarks. The filtering can be based on a set of criteria that define potentially acceptable poses for the object in the real image. In general, the criteria reflect real-world conditions in which the real image is likely to be taken and can be tailored according to the nature of the object. For example, for candidate relative poses in which the object is an automobile:
the camera should be at an altitude of between 0 meters and 5 meter relative to the ground under the automobile,
the camera should be within 20 m of the automobile,
the roll of the camera relative to the ground under the automobile is small (e.g., less than +/−10 degrees),
the position of two-dimensional landmarks in the estimated pose should be consistent with the positons of the corresponding landmarks on the 3D model, e.g., as determined by back-projection of the two-dimensional landmarks in the real image onto the 3D model, and
the boundary of the object identified by another technique should largely match the boundary of the object that would result from the predicted pose.

If a candidate relative pose does not satisfy such criteria, then it can be discarded or otherwise excluded from subsequent data processing activities.

At 725, the system performing process 700 estimates the relative pose of the object in the real image based on the remaining (unfiltered) candidate relative poses. For example, if only a single candidate relative pose remains, it can be considered to be final estimate of the relative pose. As another example, if multiple candidate relative poses remain, a difference between the candidate relative poses can be determined and used to conclude that the relative pose has been reasonably estimated. The remaining candidate relative poses can then be averaged or otherwise combined to estimate the relative pose.

FIG. 9 is a histogram that represents the accuracy of relative pose predictions made using process 700 (FIG. 7). In the histogram, position along the y-axis indicates the number count of pose predictions. Position along the x-axis indicates the error in the each of the pose predictions as a distance, in cm, between the predicted relative camera position and the ground-truth camera position. In this histogram, the angle of the camera is not taken into account.

Of 200 images for which pose was predicted, no pose was predicted for 17. For the remaining 183 images, the average accuracy was 26 centimeters.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by data processing apparatus for training a device for estimating the relative pose of an imaging device and an object in a two-dimensional image, the method comprising:
identifying a 3D model of the object;
identifying landmarks on the 3D model of the object;
projecting the 3D model into a collection of two-dimensional images with knowledge of the location of the landmarks from the 3D model on the projection; and
training a landmark-detection machine learning model to identify the landmarks in the collection of two-dimensional images, wherein the landmark-detection machine learning model is part of a device for estimating the relative pose of an imaging device.

2. The method of claim 1, further comprising:
estimating relative poses of the object in two-dimensional images using the device that includes the landmark-detection machine learning model;
determining a correctness of the estimates of the relative poses; and
further training the landmark-detection machine learning model based on the correctness of the estimates of the relative poses.

3. The method of claim 2, wherein:
the relative poses of the object are estimated in the collection of two-dimensional images into which the 3D model is projected.

4. The method of claim 3, wherein determining the correctness of the estimates of the relative poses comprises:
constraining relative poses of the projections of the 3D model into the collection of two-dimensional images; and
classifying any estimate of the relative pose that does not satisfy the constraints as incorrect.

5. The method of claim 1, wherein identifying the landmarks on the 3D model of the object comprises:
rendering a collection of two-dimensional images of the object by projecting the 3D model of the object onto two dimensions;
assigning different regions of the object in the two-dimensional images to respective parts of the object;
determining distinguishable regions of the parts of the object using the assigned regions; and
projecting the distinguishable regions back onto the 3D model of the object to identify the landmarks on the 3D model of an object.

6. A method performed by data processing apparatus for estimating the relative pose of an imaging device and an object in a two-dimensional image of the object, the method comprising:
detecting landmarks on the object in the two-dimensional image;
filtering the plurality of landmarks to establish a plurality of subsets of the detected landmarks;
calculating, using each of the respective subsets of the detected landmarks, candidate relative poses of the object in the two-dimensional image; and
estimating the relative pose of an imaging device and an object based on at least one of the candidate relative poses.

7. The method of claim 6, further comprising filtering the candidate relative poses of the object.

8. The method of claim 7, wherein criteria for filtering the candidate relative poses reflect real-world conditions in which a real image is likely to be taken.

9. The method of claim 6, wherein estimating the relative pose of the imaging device and the object comprises averaging multiple of the candidate relative poses.

10. The method of claim 6, wherein detecting the landmarks on the object comprises detecting the landmarks using a landmark-detection machine learning model, wherein the landmark-detection machine learning model has been trained by a process that includes identifying a 3D model of the object;
identifying landmarks on the 3D model of the object;
projecting the 3D model into a collection of two-dimensional images with knowledge of the location of the landmarks from the 3D model on the projection; and
training the landmark-detection machine learning model to identify the landmarks in the collection of two-dimensional images.

11. A method performed by data processing apparatus for identifying landmarks on a 3D model of an object, the method comprising:
rendering a collection of two-dimensional images of an object by projecting the 3D model of the object onto two dimensions;
assigning different regions of the object in the two-dimensional images to respective parts of the object;
determining distinguishable regions of the parts of the object using the assigned regions; and
projecting the distinguishable regions back onto the 3D model of the object to identify the landmarks on the 3D model of an object.

12. The method of claim 11, wherein determining the distinguishable regions of the parts comprises detecting corners of projections of the parts in the two-dimensional images.

13. The method of claim 11, further comprising reducing a number of the distinguishable regions prior to projection back onto the 3D model.

14. The method of claim 13, wherein reducing the number of the distinguishable regions comprises filtering distinguishable regions that are close to an outer boundary of the object.

15. The method of claim 13, wherein reducing the number of the distinguishable regions comprises:
clustering back-projections of the distinguishable regions onto the 3D model from different of the two-dimensional images; and
discarding outliers of the distinguishable regions.

16. The method of claim 11, wherein rendering the collection of two-dimensional images of the object comprises:
permuting the object; and
projecting the permutations of the 3D model onto two dimensions.

17. The method of claim 11, wherein rendering the collection of two-dimensional images of the object comprises varying to rendering to mimic variation in a characteristic of an imaging apparatus, to mimic variation in a characteristic of image processing applicable to two-dimensional images, or to mimic variation in an imaging condition.
